(19) United States
(12) Patent Application Publication
(10) Pub. No.: US 2010/0135465 A1
(43) Pub. Date: Jun. 3, 2010

(54) Rotating anticathode X-ray generating apparatus and X-ray generating method

(75) Inventor: Noriyoshi Sakabe, Tsukuba-shi (JP)

Correspondence Address: OLIFF & BERRIDGE, PLC, P.O. BOX 320850, ALEXANDRIA, VA, 22320-4850, US

(73) Assignees: NORIYOSHI SAKABE, Tsukuba-shi (JP); KIWAKO SAKABE, Tsukuba-shi (JP); NAOMI SHIMURA, Suita-shi (JP)

(21) Appl. No.: 12/656,455

(22) Filed: Jan. 29, 2010

Related U.S. Application Data
(63) Continuation of application No. 12/010,815, filed on Jan. 30, 2008.

(30) Foreign Application Priority Data
Aug. 28, 2007 (JP) 2007-220835

(51) Int. Cl. H01J 35/10

(52) U.S. Cl. 378/144

(57) ABSTRACT

A rotating anticathode X-ray generating apparatus, includes: a rotating anticathode; an electron beam source for irradiating an electron beam onto the rotating anticathode so that an irradiating direction of the electron beams is set equal to a direction of a centrifugal force caused by a rotation of the rotating anticathode; and a first material for forming a film so as to cover at least an electron beam irradiating portion of the rotating anticathode and to suppress an evaporation of a second material making the rotating anticathode from the electron beam irradiating portion, wherein the first material is disposed in a path of the electron beam so that the first material is configured so as to be converted into the film through an irradiation of the electron beam.

### CROSS-REFERENCE TO RELATED APPLICATIONS

This is a Continuation of application Ser. No. 12/010,815 filed Jan. 30, 2008, which in turn claims the benefit of Japanese Patent Application No. 2007-220835, filed on Aug. 28, 2007. The disclosures of the prior applications are hereby incorporated by reference herein in their entirety.

### BACKGROUND OF THE INVENTION

1. Field of the Invention

This invention relates to a rotating anticathode X-ray generating apparatus and an X-ray generating method for generating an X-ray with ultrahigh brightness.

2. Description of the Related Art

In X-ray diffraction measurement, it may be required to irradiate an X-ray with as high intensity as possible onto a sample. In this case, a conventional rotating anticathode type X-ray generating apparatus would be employed for the X-ray diffraction measurement.

The rotating anticathode X-ray generating apparatus is configured such that an electron beam is irradiated onto the outer surface of the columnar anticathode (target) in which a cooling medium is flowed while the anticathode is rotated at high speed. In comparison with a stationary target X-ray generating apparatus, the rotating anticathode X-ray generating apparatus can exhibit extreme cooling efficiency because the irradiating position of the electron beam on the anticathode changes with time. Therefore, in the rotating anticathode X-ray generating apparatus, the electron beam can be irradiated onto the anticathode in large electric current, thereby generating an X-ray with high intensity (brightness).

By the way, the intensity of the resultant X-ray generated is in proportion to the electric power (current×voltage) to be applied between the cathode and the anticathode. On the other hand, since the brightness of the X-ray can be represented by (electric power)/(area of electron beams on target), the maximum value in output of the X-ray depends largely on the area of the electron beam on the target. For example, the output intensity of the X-ray can be enhanced only to 1.2 kW at a maximum in the conventional laboratory rotating Cu anticathode type X-ray generating apparatus when the electron beam is irradiated onto the target at a spot size of 0.1×1 mm, and also only to 3.5 kW at a maximum in an ultrahigh brightness rotating anticathode X-ray generating apparatus.

In this point of view, such a technique is disclosed in Japanese Patent Application Laid-open No. 2004-172135 as irradiating the electron beam onto the inner surface of the cylindrical portion which is rotated around the center axis of the rotating anticathode X-ray generating apparatus and heating the electron beam irradiating portion beyond the melting point of the material making the cylindrical portion, thereby generating the high bright X-ray. In this case, since the electron beam irradiating portion is heated beyond the melting point of the material of the cylindrical portion, the electron beam irradiating portion is at least partially melted. However, since the electron beam irradiating portion is held on the cylindrical portion by the centrifugal force caused by the rotation of the rotating anticathode, the melted portion of the electron beam irradiating portion can not be splashed.

In the conventional technique, however, since the electron beam irradiating portion is at least partially melted through the heating beyond the melting point of the material of the cylindrical portion, the area around the electron beam irradiating portion is heated to a relatively high temperature so that the vapor pressure of the area becomes high. As a result, the rotating anticathode (cylindrical portion) is consumed remarkably so that the utilization efficiency of the rotating anticathode may be deteriorated.

### [Patent Application No. 1]

Japanese Patent Application Laid-open No. 2004-172135

### BRIEF SUMMARY OF THE INVENTION

It is an object of the present invention, in a rotating anticathode X-ray generating apparatus and an X-ray generating method, to suppress the consumption of the rotating anticathode by the irradiation of electron beams onto the rotating anticathode.

In order to achieve the above object, the present invention relates to a rotating anticathode X-ray generating apparatus, including: a rotating anticathode; an electron beam source for irradiating an electron beam onto the rotating anticathode so that an irradiating direction of the electron beams is set equal to a direction of a centrifugal force caused by a rotation of the rotating anticathode; and a first material for forming a film so as to cover at least an electron beam irradiating portion of the rotating anticathode and to suppress an evaporation of a second material making the rotating anticathode from the electron beam irradiating portion, wherein the first material is disposed in a path of the electron beam so that the first material is configured so as to be converted into the film through an irradiation of the electron beam.

Moreover, the present invention relates to a method for generating an X-ray, including the steps of: irradiating an electron beam onto a rotating anticathode so that an irradiating direction of the electron beams is set equal to a direction of a centrifugal force caused by a rotation of the rotating anticathode; and providing a first material for forming a film so as to cover at least an electron beam irradiating portion of the rotating anticathode and to suppress an evaporation of a second material making the rotating anticathode from the electron beam irradiating portion, wherein the first material is disposed in a path of the electron beam so that the first material is configured so as to be converted into the film through an irradiation of the electron beam.

According to the rotating anticathode X-ray generating apparatus and the X-ray generating method, the film forming material (first material) is provided in the apparatus in advance, thereby to be converted into the film covering the electron beam irradiating portion under the condition that the film forming material (the first material) is disposed in a path of the electron beam when the intended X-ray is generated through the irradiation of the electron beam. Therefore, even though the electron beam irradiating portion is heated beyond the melting point of the second material making the rotating anticathode so that the vapor pressure of the material is increased, the evaporation of the material is prevented by the film. As a result, the consumption of the rotating anticathode due to the irradiation of the electron beam can be reduced.

Moreover, the film to cover the electron beam irradiating portion can be formed simultaneously when the X-ray is generated because the first material is disposed in a path of the electron beam so that the first material is configured so as to be converted into the film through an irradiation of the electron beam. Therefore, the film is not required to be formed in advance before the X-ray is generated and then, can be formed simultaneously at the generation of the X-ray. In this point of view, the operational efficiency relating to the X-ray generating apparatus and the X-ray generating method can be enhanced.

In addition, since the electron beam is directed at the surface for the film to be formed, the film can be selectively formed on the surface of the rotating anticathode.

The film may be formed in the initial operation, that is, the break-in period of the rotating anticathode X-ray generating apparatus. In this case, since the film is already formed so as to cover the electron beam irradiating portion when the X-ray is generated, the evaporation of the second material making the rotating anticathode at the initial stage of the X-ray generating process can be suppressed. Therefore, the operational efficiency relating to the X-ray generating apparatus and the X-ray generating method can be enhanced.

In an embodiment, the film forming material is configured so as to be converted into the film through a heat caused by the electron beam. In this case, the film forming material (the first material) is decomposed and/or composed by the heat so that the film can be formed so as to cover the electron beam irradiating portion. In this embodiment, it is desired that the film forming material (the first material) is disposed in the vicinity of the electron beam irradiating portion of the rotating anticathode.

The electron beam source may be configured so as to control the beam diameter of the electron beam so that the beam diameter of the electron beam at the irradiation for the film forming material (the first material) is set larger than the beam diameter of the electron beam at the irradiation for the rotating anticathode because the intensity of the electron beam required in the decomposition and composition of the film forming material (the first material) is different from the intensity and/or density of the electron beam required in the generation of the X-ray. Namely, with the generation of the X-ray, the beam diameter of the electron beam is decreased so as to increase the density of the electron beam and with the decomposition and composition of the film forming material (the first material), the beam diameter of the electron beam is increased so as to increase the irradiating area of the electron beam for the film forming material (the first material) in view of the forming efficiency of the film.

It is desired that the interior pressure of the rotating anticathode X-ray generating apparatus is set to a pressure in the order of 10⁻⁶ Torr or less when the film forming material (the first material) is converted into the film. If the interior pressure of the vacuum chamber is beyond the order of 10⁻⁶ Torr, electric discharge is likely to occur at the electron beam source and the cathode of the electron beam source may be consumed.

In still another embodiment, the first material is not soluble for the rotating anticathode. If the film made of the first material is solid-solved with the rotating anticathode, the film may disappear so as not to suppress the evaporation of the second material making the rotating anticathode sufficiently.

In this point of view, it is desired that the relative density and vapor pressure of the film making from the first material, are smaller than the relative density and vapor pressure of the second material making the rotating anticathode. For example, the film forming material (the first material) includes carbon so that the film includes carbon. Concretely, the carbon film and the carbon containing material have a smaller relative density and vapor pressure. Then, the carbon film and the carbon containing material are unlikely to be solid-solved with the rotating anticathode made of Cu or the like and to be evaporated. Moreover, since the carbon film and the carbon material has electric conduction to some degrees, the electric charge of the film to cover the electron beam irradiating portion can be reduced so that the film can not be broken when the electron beam is irradiated.

If the film forming material (the first material) includes carbon, the film forming material is easily available because the film forming material (the first material) is solid (including gel). As a result, the cost in the apparatus and method of the present invention can be reduced.

According to the present invention can be suppressed, in a rotating anticathode X-ray generating apparatus and an X-ray generating method, the consumption of the rotating anticathode by the irradiation of electron beams onto the rotating anticathode.

### BRIEF DESCRIPTION OF THE SEVERAL VIEWS OF THE DRAWINGS

FIG. 1 is a structural view showing the essential part of a rotating anticathode X-ray generating apparatus according to the present invention.

FIG. 2 is an enlarged plan view showing the area containing the deflecting electron lens in the rotating anticathode X-ray generating apparatus shown in FIG. 1.

FIG. 3 is an enlarged side plan view showing the area containing the deflecting electron lens in the rotating anticathode X-ray generating apparatus shown in FIG. 1.

FIG. 4 is an enlarged side plan view showing the area containing the deflecting electron lens in another rotating anticathode X-ray generating apparatus according to the present invention.

FIG. 5 is an enlarged side plan view showing the area containing the deflecting electron lens in still another rotating anticathode X-ray generating apparatus according to the present invention.

### DETAILED DESCRIPTION OF THE INVENTION

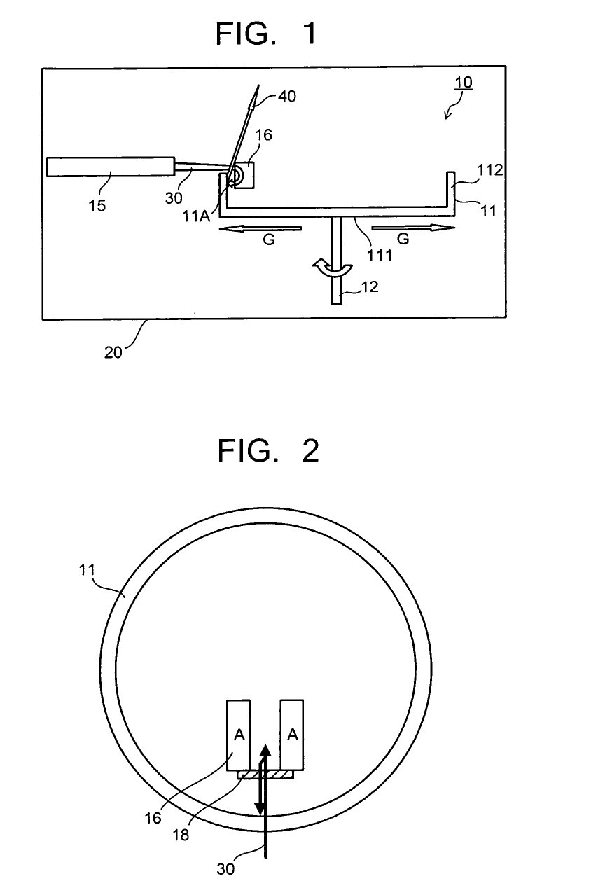

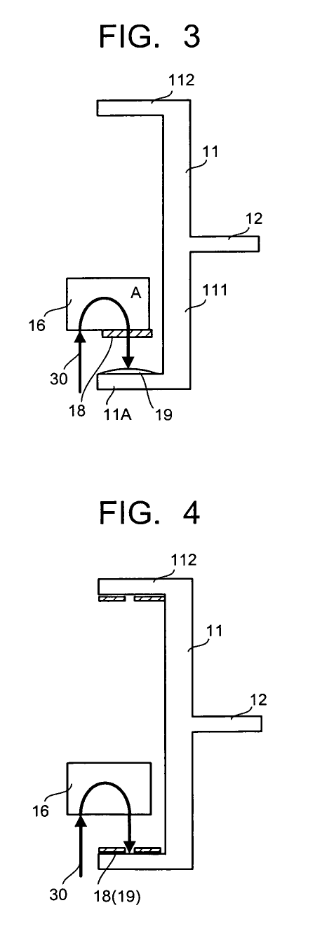

Hereinafter, the present invention will be described in detail with reference to the drawings. FIG. 1 is a structural view showing the essential part of a rotating anticathode X-ray generating apparatus according to the present invention. FIG. 2 is an enlarged plan view showing the area containing the deflecting electron lens in the rotating anticathode X-ray generating apparatus shown in FIG. 1. FIG. 3 is an enlarged side plan view showing the area containing the deflecting electron lens in the rotating anticathode X-ray generating apparatus shown in FIG. 1.

As shown in FIG. 1, the rotating anticathode X-ray generating apparatus 10 includes an rotating anticathode 11 and an electron gun 15 as an electron beam source. The rotating anticathode 11 includes a main body 111 mechanically connected with a rotating shaft 12 and a cylindrical portion 112 provided vertically for the main body 111. The cylindrical portion 112 constitutes the side wall of the rotating anticathode 11. As shown in FIG. 2, the main body 111 is formed almost circularly so that the cylindrical portion 112 is provided vertically at the periphery of the main body 111. The rotating anticathode 11 is rotated around the rotating shaft 12 attached to the bottom surface thereof (the bottom surface of the main body 111), e.g., along the direction designated by the arrow.

The rotating anticathode 11 and the electron gun 15 are provided in a vacuum chamber 20.

An electron beam 30 is emitted horizontally from the electron gun 15, and deflected by about 180 degrees with a deflecting electron lens 16, and irradiated onto the inner wall of the cylindrical portion 112 of the rotating anticathode 11, thereby forming an electron beam irradiating portion 11A. The electron beam irradiating portion 11A is excited by the irradiation of the electron beam 20 to generate an intended X-ray 40.

Then, a material 18 for forming a film is provided at the outlet of the deflecting electron lens 16 for the electron beam 30 so as to be opposite to the cylindrical portion 112 of the rotating anticathode 11. The material 18 is a raw material for forming a film 19 on the electron beam irradiating portion 11A of the rotating anticathode 11, and appropriately selected dependent on the sort of material of the film 19.

The film 19 is formed on the electron beam irradiating portion 11A and the area around the portion 11A so that even though the electron beam irradiating portion 11A is heated beyond the melting point of the material making the portion 11A, that is, the rotating anticathode 11 so as to increase the vapor pressure of the material, the evaporation of the material can be suppressed. Therefore, it is desired that the film 19 and the material 18 are made of a material not soluble for the material making the rotating anticathode 11 such as Cu or Co and having a low vapor pressure at a relatively high temperature at the irradiation of the electron beam 30 with high intensity.

Since the material 18 as a raw material for forming the film 19 is formed on the deflecting electron lens 16 in advance, the material 18 is solid. In view of the easiness of acquisition of the material 18, therefore, it is desired that the material 18 includes carbon so that the film 19 includes carbon.

Concretely, if the material 18 is made of graphite, the electron beam 30 is irradiated to the graphite material 18 in the X-ray generating process as described below. In this case, the graphite material 18 is gradually broken and scattered so that the scattered graphite is deposited on the electron beam irradiating portion 11A of the rotating anticathode 11 to be the carbon film 19 so as to cover the electron beam irradiating portion 11A.

On the other hand, the material 18 for forming the film 19 may be configured such that a hydrocarbon-based polymer film is formed on a carbon matrix. Alternatively, the material 18 may be configured such that the pellets made of the hydrocarbon-based polymer are embedded in a given area of the vacuum chamber 20. Alternatively, the material 18 may be configured such that a vacuum grease not containing silicone is applied onto a given area of the vacuum chamber 20. With the material 18 configured as the pellets and the vacuum grease, the material 18 is heated and excited by the irradiation of the electron beam 30 so that the dissolved carbon is deposited in film onto the electron beam irradiating portion 11A to be the carbon film 19 so as to cover the electron beam irradiating portion 11A. In this case, since the film 19 is formed through the heating for the pellets made of hydrocarbon polymer or the vacuum grease, the intensity of the electron beam 30 for forming the film 19 can be reduced in comparison with the intensity of the electron beam 30 for forming the film 19 from the graphite.

Then, the X-ray generating process using the rotating anticathode X-ray generating apparatus shown in FIGS. 1 to 3 will be described. As shown in FIGS. 1 and 3, the rotating anticathode 11 is rotated at a predetermined angular velocity around the rotating shaft 12 by a drive such as a motor(not shown). Then, a given centrifugal force G is generated outward at the rotating anticathode 11 around the rotating shaft 12. Then, the electron beam 30 is emitted from the electron gun 15 so that the direction of the centrifugal force G can be parallel to the irradiating direction of the electron beam 30. In this case, the electron beam irradiating portion 11A can be easily formed at the inner wall of the cylindrical portion 112.

In this case, the electron beam irradiating portion 11A is excited by the irradiation of the electron beam 30 to generate the X-ray 40. As is apparent from FIG. 1, the direction of the centrifugal force G is set equal to the irradiating direction of the electron beam 30. Therefore, even though the intensity of the electron beam 30 is increased to partially melt the electron beam irradiating portion 11A of the rotating anticathode 11, e.g., by a depth of several hundred micrometers, the melted portion of the electron beam irradiating portion 11A is held on the cylindrical portion 112 by the centrifugal force G. On the other hand, since the electron beam 30 with high intensity is irradiated onto the electron beam irradiating portion 11A, the brightness of the X-ray 40 to be generated from the electron beam irradiating portion 11A is increased.

In this case, the electron beam irradiating portion 11A and the area around the electron beam irradiating portion 11A are heated to a temperature beyond the melting point of the material making the rotating anticathode 11 with the melting of the electron beam irradiating portion 11A. Therefore, the material of the rotating anticathode 11 vaporizes conspicuously with the generation of the X-ray 40 without the film 19.

In this embodiment, however, the material 18 is irradiated, heated and excited by the electron beam 30 to form the film 19 so as to cover the electron beam irradiating portion 11A when the electron beam 30 is deflected at the deflecting electron lens 16, and incident onto the cylindrical portion 112 of the rotating anticathode 11, thereby generating the X-ray 40. As a result, the evaporation of the material making the rotating anticathode 11 can be suppressed. In other words, the X-ray 40 with high brightness can be generated under the condition that the consumption of the rotating anticathode (target material) is suppressed.

In the formation of the film 19 from the material 18, the interior of the vacuum chamber 20, that is, the rotating anticathode x-ray generating apparatus 10 is preferably set to a pressure in the order of 10⁻⁶ Torr or less. If the interior pressure of the vacuum chamber 20 is beyond the order of 10⁻⁶ Torr, electric discharge is likely to occur between the cathode and anode of the electron gun 15 and the electron emission efficiency at the cathode may be deteriorated. Moreover, the material 18 may be partially deposited on the inner wall of the electron gun 15 so that the electron gun 15 may be broken between the cathode and anode thereof, which means the dielectric breakdown of the electron gun 15. In addition, the cathode of the electron gun 15 may be consumed.

In this embodiment, the film 19 is formed simultaneously when the X-ray 40 is generated. However, the film 19 may be formed in the initial operation, that is, the break-in period of the rotating anticathode X-ray generating apparatus 10. In this case, since the film 19 is already formed so as to cover the electron beam irradiating portion 11A when the X-ray 40 is generated, the evaporation of the material making the rotating anticathode 11 at the initial stage of the X-ray generating process can be suppressed.

The electron gun 15 can be configured such that the beam diameter of the electron beam 30 at the irradiation for the material 18 is set larger than the beam diameter of the electron beam 30 at the irradiation for the rotating anticathode 11 because the intensity of the electron beam 30 required in the decomposition and composition of the material 18 is different from the intensity of the electron beam 30 required in the generation of the X-ray 40. Namely, with the generation of the X-ray 40, the beam diameter of the electron beam 30 is decreased so as to increase the density of the electron beam 30 and with the decomposition and composition of the material 18, the beam diameter of the electron beam 30 is increased so as to increase the irradiating area of the electron beam 30 for the material 18 in view of the forming efficiency of the film 19.

In the above-described case, the electron beam from the electron gun 15 can form the film 19 at the break-in period of the rotating anticathode X-ray generating apparatus 10 and generate the X-ray in the X-ray generating process. In other words, the formation of the film 19 and the generation of the X-ray 40 can be performed by a single electron gun (i.e., the electron gun 15). In the X-ray generating process, if the film 19 is consumed so that the evaporation of the material making the rotating anticathode 11 can not be suppressed sufficiently, the film 19 is appropriately compensated by increasing the beam diameter of the electron beam 30 for forming the film 19.

FIG. 4 is an enlarged side plan view showing the area containing the deflecting electron lens in another rotating anticathode X-ray generating apparatus according to the present invention. In this embodiment, the rotating anticathode X-ray generating apparatus is configured as the rotating anticathode X-ray generating apparatus relating to FIGS. 1-3 except that the material 18 for forming the film 19 is formed at a different area. In this embodiment, therefore, the different characteristics will be described and the similar or corresponding characteristics will not be described.

In the embodiment relating to FIGS. 1 to 3, the material 18 is formed at the position of the deflecting electron lens 16 opposite to the cylindrical portion 112 of the rotating anticathode 11. In this embodiment, in contrast, the material 18 is formed on the cylindrical portion 112 except the electron beam irradiating portion 11A. Therefore, the material 18 is irradiated, heated and excited by the electron beam 30 to form the film 19 so as to cover the electron beam irradiating portion 11A when the electron beam 30 is deflected at the deflecting electron lens 16, and incident onto the cylindrical portion 112 of the rotating anticathode 11, thereby generating the X-ray 40. In this case, the material 18 is decomposed and scattered by the heating caused by the radiation of the electron beam 30.

The scattered material is at least partially passed through the space between the magnetic poles of the deflecting electron lens 16 and deposited onto the inner surface of the cylindrical portion 112 of the rotating anticathode 11 against which the material 18 is faced as well as near the irradiation position by electron beam. The forming rate of the film 19 in this embodiment becomes smaller than the forming rate of the film 19 in the embodiment relating to FIGS. 1 to 3, but the adherence strength of the film 19 in this embodiment can be increased more than the adherence strength of the film 19 in the embodiment relating to FIGS. 1 to 3 because in this embodiment, the film 19 is formed on the clean inner surface of the cylindrical portion 112.

Even if the material 18 is not adhered strongly onto the cylindrical portion 112, the material 18 can be stably held on the cylindrical portion 112 by the centrifugal force G caused by the rotation of the rotating anticathode 11 in the X-ray generating process.

As a result, the evaporation of the material making the rotating anticathode 11 can be suppressed sufficiently at the generation of the X-ray 40, so that the X-ray 40 with high brightness can be generated under the condition that the evaporation of the material making the rotating anticathode (target material) is suppressed.

In this embodiment, the film 19 is formed simultaneously when the X-ray 40 is generated. However, the film 19 may be formed in the initial operation, that is, the break-in period of the rotating anticathode X-ray generating apparatus 10. In this case, since the film 19 is already formed so as to cover the electron beam irradiating portion 11A when the X-ray 40 is generated, the evaporation of the material making the rotating anticathode 11 at the initial stage of the X-ray generating process can be suppressed.

The material 18 is a raw material for forming a film 19 on the electron beam irradiating portion 11A of the rotating anticathode 11, and appropriately selected dependent on the sort of material of the film 19. Since the film 19 is formed on the cylindrical portion 112 of the rotating anticathode 11 in advance, the material 18 is preferably solid. Moreover, since the film 19 is formed on the electron beam irradiating portion 11A and the area around the portion 11A so that even though the electron beam irradiating portion 11A is heated beyond the melting point of the material making the portion 11A, that is, the rotating anticathode 11 so as to increase the vapor pressure of the material, the evaporation of the material can be suppressed.

Therefore, it is desired that the film 19 and the material 18 are made of a material not soluble for the material making the rotating anticathode 11 such as Cu or Co and having a low vapor pressure at a relatively high temperature at the irradiation of the electron beam 30 with high intensity. In view of the easiness of acquisition of the material 18, therefore, it is desired that the material 18 includes carbon so that the film 19 includes carbon. In this case, the rotating anticathode 11 is preferably made of a material not containing iron because iron is likely to form a solid-solution with carbon.

The material 18 for forming the film 19 may be configured such that a hydrocarbon-based polymer film is formed on a carbon matrix. Alternatively, the material 18 may be configured such that the pellets made of the hydrocarbon-based polymer are embedded in a given area of the vacuum chamber 20. Alternatively, the material 18 may be configured such that a vacuum grease not containing silicone is applied onto a given area of the vacuum chamber 20. With the material 18 configured as the pellets and the vacuum grease, the material 18 is heated and excited by the irradiation of the electron beam 30 so that the dissolved carbon is deposited in film onto the electron beam irradiating portion 11A to be the carbon film 19 so as to cover the electron beam irradiating portion 11A and the area around the portion 11A.

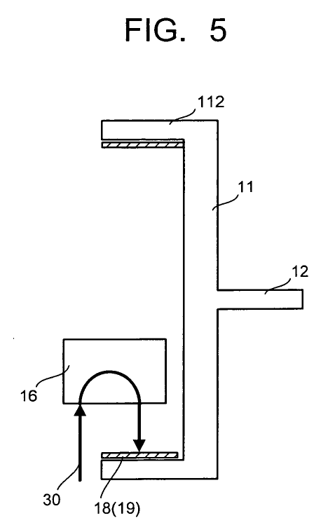

FIG. 5 is an enlarged side plan view showing the area containing the deflecting electron lens in still another rotating anticathode X-ray generating apparatus according to the present invention. In this embodiment, the rotating anticathode X-ray generating apparatus is configured as the rotating anticathode X-ray generating apparatus relating to FIGS. 1-3 except that the material 18 for forming the film 19 is formed at a different area. In this embodiment, therefore, the different characteristics will be described and the similar or corresponding characteristics will not be described.

In the embodiment relating to FIGS. 1 to 3, the material 18 is formed at the position of the deflecting electron lens 16 opposite to the cylindrical portion 112 of the rotating anticathode 11. In this embodiment, in contrast, the material 18 is formed on the cylindrical portion 112 containing the electron beam irradiating portion 11A. Therefore, the material 18 is irradiated, heated and excited by the electron beam 30 to form the film 19 so as to cover the electron beam irradiating portion 11A when the electron beam 30 is deflected at the deflecting electron lens 16, and incident onto the cylindrical portion 112 of the rotating anticathode 11, thereby generating the X-ray 40.

In this case, the material 18 is decomposed and scattered by the heating caused by the radiation of the electron beam 30. The scattered material almost remains at the same area as the material 18, different from the embodiment relating to FIG. 4 so that the film 19 is formed directly on the same area as the material 18.

Even if the material 18 is not adhered strongly onto the cylindrical portion 112, the material 18 can be stably held on the cylindrical portion 112 by the centrifugal force G caused by the rotation of the rotating anticathode 11 in the X-ray generating process.

As a result, the evaporation of the material making the rotating anticathode 11 can be suppressed sufficiently at the generation of the X-ray 40, so that the X-ray 40 with high brightness can be generated under the condition that the evaporation of the material making the rotating anticathode (target material) can be suppressed sufficiently.

In this embodiment, the film 19 is formed simultaneously when the X-ray 40 is generated. However, the film 19 may be formed in the initial operation, that is, the break-in period of the rotating anticathode X-ray generating apparatus 10. In this case, since the film 19 is already formed so as to cover the electron beam irradiating portion 11A when the X-ray 40 is generated, the evaporation of the material making the rotating anticathode 11 at the initial stage of the X-ray generating process can be suppressed.

In this embodiment, the material 18 can be formed in advance as follows.

First of all, a vacuum grease not containing silicone (hereinafter, abbreviated as a “vacuum grease”) or the like is applied as the material 18 over the cylindrical portion 112 of the rotating anticathode 11. Secondary, a mixture of the vacuum grease and micro crystalline graphite is applied as the material 18 over the cylindrical portion 112 of the rotating anticathode 11. Thirdly, the vacuum grease is applied over the cylindrical portion 112 and a carbon film is applied as the material 18 on the grease applied on the cylindrical portion 112.

In the second method, since the graphite particles are provided in advance, the decomposed carbon is deposited on the graphite particles so as to join the graphite particles one another. Therefore, the forming rate of the film 19 can be developed. The third method is an idealistic method. In this case, the grease functions as fixing the carbon film as the material 18 onto the cylindrical portion 112 so that the carbon film is formed directly on the cylindrical portion 112. The grease is carbonized by the irradiation of the electron beam 30 so that the thus obtained carbon strengthen the connection between the material 18 and the cylindrical portion 112 (target metal) and embeds the gaps of the material 18. As a result, the forming rate of the film 19 can be developed.

Although the present invention was described in detail with reference to the above examples, this invention is not limited to the above disclosure and every kind of variation and modification may be made without departing from the scope of the present invention.

For example, in the case that the material 18 exhibits a relatively large vapor pressure at a relatively low temperature, the material 18 may be formed on the side surface of the deflecting electron lens 16 to which the electron beam 30 is not directly irradiated or on the main body 111 of the rotating anticathode 11.

Moreover, in the above-described embodiment, the cylindrical portion 112 is provided vertically at the periphery of the main body 111, but may be inclined toward the rotating shaft 12 by several degrees from the normal line of the main body 111. In this case, even though the electron beam irradiating portion 11A is melted, the melted portion of the electron beam irradiating portion 11A can be prevented more effectively. Then, the cylindrical portion 112 may be inclined outward from the rotating shaft 12. In this case, the generated X-ray 30 can be taken out easily.

What is claimed is:

1. A rotating anticathode X-ray generating apparatus, comprising:
a rotating anticathode;
an electron beam source for irradiating an electron beam onto said rotating anticathode so that an irradiating direction of said electron beams is set equal to a direction of a centrifugal force caused by a rotation of said rotating anticathode; and
a first material for forming a film so as to cover at least an electron beam irradiating portion of said rotating anticathode and to suppress an evaporation of a second material making said rotating anticathode from said electron beam irradiating portion,
wherein said first material is disposed in a path of said electron beam so that said first material is configured so as to be converted into said film through an irradiation of said electron beam.

2. The generating apparatus as set forth in claim 1,
wherein said first material is configured so as to be converted into said film through a heat caused by said electron beam.

3. The generating apparatus as set forth in claim 2,
wherein an interior pressure of said rotating anticathode X-ray generating apparatus is set to a pressure in the order of 10⁻⁶ Ton or less when said first material is converted into said film.

4. The generating apparatus as set forth in claim 1,
wherein said first material is not soluble for said rotating anticathode and having a relative density smaller than a relative density of said second material making said rotating anticathode.

5. The generating apparatus as set forth in claim 3,
wherein said first material includes carbon so that said film includes carbon.

6. The generating apparatus as set forth in claim 1,
wherein said rotating anticathode is configured so as to be partially melted by an irradiation of said electron beam.

7. The generating apparatus as set forth in claim 1,
wherein said electron beam source is configured so as to control a beam diameter of said electron beam so that a beam diameter of said electron beam at an irradiation for said first material is set larger than a beam diameter of said electron beam at an irradiation for said rotating anticathode.

8. A method for generating an X-ray, comprising the steps of:
irradiating an electron beam onto a rotating anticathode so that an irradiating direction of said electron beams is set equal to a direction of a centrifugal force caused by a rotation of said rotating anticathode; and
providing a first material for forming a film so as to cover at least an electron beam irradiating portion of said rotating anticathode and to suppress an evaporation of a second material making said rotating anticathode from said electron beam irradiating portion,
wherein said first material is disposed in a path of said electron beam so that said first material is configured so as to be converted into said film through an irradiation of said electron beam.

9. The generating method as set forth in claim 8,
wherein said first material is configured so as to be converted into said film through a heat caused by said electron beam.

10. The generating method as set forth in claim 8,
wherein an interior pressure of said rotating anticathode X-ray generating apparatus is set to a pressure in the order of 10⁻⁶ Torr or less when said first material is converted into said film.

11. The generating method as set forth in claim 8,
wherein said first material is not soluble for said rotating anticathode and having a relative density smaller than a relative density of said second material making said rotating anticathode.

12. The generating method as set forth in claim 10,
wherein said film forming material includes carbon so that said film includes carbon.

13. The generating method as set forth in claim 8,
wherein said rotating anticathode is configured so as to be partially melted by an irradiation of said electron beam.

14. The generating method as set forth in claim 8,
wherein said electron beam source is configured so as to control a beam diameter of said electron beam so that a beam diameter of said electron beam at an irradiation for said film forming material is set larger than a beam diameter of said electron beam at an irradiation for said rotating anticathode.
